(19) United States
(12) Patent Application Publication
(10) Pub. No.: US 2025/0082129 A1
(43) Pub. Date: Mar. 13, 2025

(54) LIQUID FROTHING SYSTEM FOR BEVERAGE BREWING MACHINE

(71) Applicants: LUIGI LAVAZZA S.p.A., Turin (IT); LAVAZZA PROFESSIONAL NORTH AMERICA LLC, West Cherster, PA (US)

(72) Inventor: Michael GARLAND, Chineham, Hampshire (GB)

(21) Appl. No.: 18/727,096

(22) PCT Filed: Jan. 5, 2023
(86) PCT No.: PCT/US2023/010246

§ 371 Date: Jul. 7, 2024

Related U.S. Application Data
(60) Provisional application No. 63/297,019, filed on Jan. 6, 2022.

(51) Int. Cl. A47J 31/44; A47J 31/52; A47J 31/54

(52) U.S. Cl. CPC A47J 31/4489; A47J 31/5253; A47J 31/542

(57) ABSTRACT

A hot beverage preparation system and related method of use. The system includes a brewing machine that can deliver a finished brewed beverage such as coffee or tea accompanied by frothed supplementary liquid such as milk or milk substitute. The supplementary liquid is heated and frothed by a superheated jet or stream of water in liquid state dispensed from a nozzle the machine. This permits a less volume of water to be used to heat liquid which minimizes dilatation of the brewed beverage. The superheated water is injected directly into the supplementary liquid without contact with the nozzle which prevents cross-contamination. The system may use tandem water boiler to progressively heat the water to superheated conditions. A flow bypass may be provided which extracts and mixes heated water output from each of two boilers at different temperatures during the brewing cycle which follows the supplementary liquid heating/frothing step.

### CROSS-REFERENCE TO RELATED APPLICATIONS

The present application is a national phase entry of PCT/US2023/010246, filed Jan. 5, 2023, which claims priority to U.S. Provisional Patent Application Ser. No. 63/297,019, filed Jan. 6, 2022, the entireties of which are incorporated herein by reference.

### FIELD OF THE INVENTION

The present invention relates to machines for brewing hot beverages, and more particularly to such machines with a system for heating and frothing a supplementary dairy or non-dairy based liquid product which can be combined with the brewed beverage.

### BACKGROUND OF THE INVENTION

Some single serving brewing machines used for brewing a hot beverage such as coffee or tea may have various capabilities for heating a supplementary dairy or dairy-free liquid such as milk, almond milk, soy milk, oat milk, or the like which can be incorporated with the brewed beverage to prepare various types of beverages. These barista-comparable machines therefore allow the user to prepare hot coffee or tea-based derivative beverages such as a cappuccino, latte, macchiato, chai latte, or similar. Various brewing machines can heat and froth the milk or dairy-free milk substitute internally while others rely on the user to manually prepare the frothed liquid external to but assisted by the machine.

In the former internal milk or milk-substitute frothing category, some brewing machines may use steam to heat and foam liquid milk internally within the machine. The frothed milk may be added to the brewed beverage simultaneously with dispensing into the user's cup or afterward. Other types of hot beverage machines may mix steam or heated water inside the beverage machine with powered milk to heat and froth the liquified milk. Others mix steam with liquid milk and air internally before dispensing frothed milk to the beverage cup. These type machines however suffer the drawback of requiring frequent cleaning and flushing of the internal surfaces in contact with the milk (or dairy-free milk substitute) including the mixing chambers, flow conduits, and nozzles in order to prevent the growth of bacteria within the machine for food safety reasons.

Still other professional barista-style brewing machines in the latter external milk or milk substitute frothing category generate steam which is dispensed through an elongated nozzle or wand to heat liquid milk held in an external container placed adjacent to but outside of the machine. These nozzles/wands must be manually immersed/submerged into the milk below the surface to inject steam and froth the liquid. Frothing milk successfully however is somewhat of an art form which requires practice. In addition, such liquid contact-type steam nozzles or wands require not only frequent cleaning as well, but the manual milk-frothing operation makes these machines unsuitable for the hands-free frothed milk dispensing desired for many fully or semi-automated hot beverage brewing machines such as those used in office or commercial settings rather than brewed coffee/tea beverage retail shops.

Improvements in hot beverage brewing machines which can produce a secondary frothed liquid such as milk or dairy-free milk substitutes are therefore desired.

### SUMMARY OF THE INVENTION

The present disclosure in one aspect provides a hot beverage preparation system including a brewing machine that can vend a finished brewed beverage such as coffee or tea accompanied by frothed milk or dairy-free milk substitute in a manner which overcomes the drawbacks of the foregoing milk frothing approaches. The present system provides automated frothing of such “supplementary liquids” to produce barista-style brewed beverages which require only minimal user involvement to simply position an external beverage container or cup containing the cold milk or milk substitute for heating and frothing adjacent to the brewing machine.

Advantageously, the present hot beverage brewing machine in one non-limiting embodiment injects one or more pulses or bursts comprising a concentrated coherent free jet (e.g., “collimated”) and pressurized jet of superheated water in a liquid state into the user's container or cup of cool/cold supplementary liquid. Such supplementary liquids may include but are not limited to milk, dairy-free milk substitute, or any other liquid-containing or liquid-based products including liquid suspensions formed of liquid (e.g., water or other) and a powdered or granulated substance (e.g., hot chocolate powder, flavorings, sugar or sugar-substitute, etc.) amenable to being heated according to the present disclosure. The free dispensing end of the superheated water collimating nozzle is spaced by a separation distance apart from the surface of the supplementary liquid in the cup. The superheated water is delivered with a predetermined fluid velocity such that the liquid jet of superheated water does not flash to steam when first exposed to ambient atmospheric pressure present outside the brewing machine. The water remains in liquid state at superheated condition until the water jet strikes the surface of and enters the body of supplementary liquid. This ensures that at least a majority if not all of the thermal energy of the jet is used to heat the milk rather than being lost to the ambient atmosphere. Unlike the prior steam nozzle or wand approach which must be dunked into the milk or dairy-free milk substitute as in barista-style machines, the present system beneficially heats these supplementary liquids in a non-contact (i.e. contact free) manner. This eliminates not only the manual task of heating the milk using the steam nozzle/wand, but avoids cross-contamination requiring frequent cleaning of steam nozzles/wands, and internal flow conduits and chambers within the brewing machine in those brewing systems which internally heat the milk which is then dispensed to the user's beverage cup. In the present frothing system, the milk is only contacted by the free jet stream of superheated water.

According to one aspect, a method for preparing brewed beverage comprises: providing a beverage brewing machine exposed to atmospheric pressure; heating water in the machine to produce superheated water in a liquid state at a pressure greater than atmospheric pressure; injecting a stream of the superheated water from a collimating nozzle into a volume of a dairy or non-dairy supplementary liquid in a beverage cup; and heating and frothing the supplementary liquid with the superheated water; wherein the collimating nozzle does not contact the supplementary liquid in the beverage cup. The collimating nozzle is spaced apart from a surface of the supplementary liquid in the beverage cup by a separation distance so that the stream of superheated water travels through air before contacting the supplementary liquid in one embodiment. The separation distance is preferably selected so that the stream of superheated water does not flash to steam when exposed to the atmospheric pressure and remains in the liquid state when it mixes with the supplementary liquid in the beverage cup.

According to another aspect, a beverage brewing machine comprises: a water chamber configured to hold water; a first stage boiler fluidly coupled to an outlet of the water chamber, the first stage boiler configured to heat the water to a first temperature; a second stage boiler fluidly coupled to an outlet of the first stage boiler, the second stage boiler configured to heat the water received from the first stage boiler to a second temperature higher than the first temperature; and a flow bypass-mixing system configured to extract and bypass a portion of the water discharged by the first stage boiler around the second stage boiler and combine the bypassed portion with a discharge of the water from second stage boiler creating a combined flow of water. The combined flow of water has a third temperature between the first and second temperatures.

### BRIEF DESCRIPTION OF THE DRAWINGS

The features of the exemplary embodiments of the present invention will be described with reference to the following drawings, where like elements are labeled similarly, and in which:

FIG. 1 is a schematic diagram of one embodiment of a hot beverage preparation system comprising a beverage brewing machine with ability to heat and froth a supplementary liquid such as milk or milk substitute using superheated water in a liquid state according to the present disclosure;

FIG. 2 is a schematic diagram showing the collimated superheated water nozzle and brewed liquid dispensing nozzle of the system of FIG. 1 in relation to the beverage container or cup of the user shown positioned in the beverage dispensing of the brewing machine; and

FIG. 3 is an alternative embodiment of the hot beverage preparation machine with a flash heater for generating the superheated water.

All drawings are schematic and not necessarily to scale. Parts given a reference numerical designation in one figure may be considered to be the same parts where they appear in other figures without a numerical designation for brevity unless specifically labeled with a different part number and described herein. References to a whole figure number herein which may comprise multiple figures with the same whole number but different alphabetical suffixes shall be construed to be a general reference to all those figures sharing the same whole number, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

As used herein for the sake of brevity, a reference made to a supplementary hot beverage liquid additive such as “milk” shall be construed to collectively be a general reference to milk or dairy-free milk substitutes such as without limitation almond milk, soy milk, oat milk, or the like; all of which can be incorporated with the brewed beverage liquid such as coffee or tea to produce a variety of hot specialty beverages such as a cappuccino, latte, macchiato, or others.

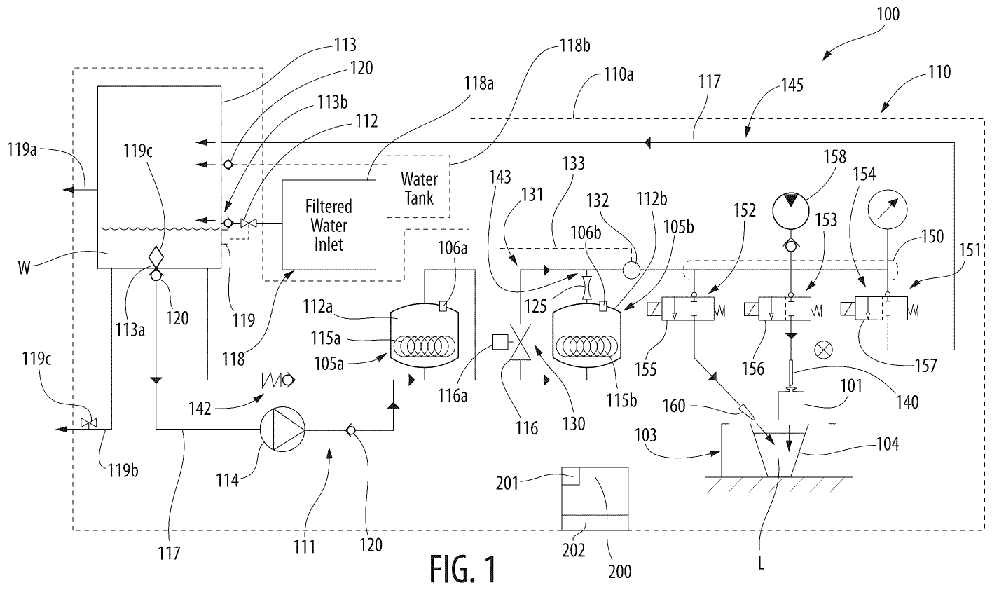

FIG. 1 is a schematic diagram of a first embodiment of a hot beverage preparation system 100 configured to generate pressurized superheated water for frothing milk. System 100 generally comprises a hot beverage brewing machine 110 according to the present disclosure which serves a platform for both the brewing function and milk frothing function. The brewing machine 110 including an outer enclosure or housing 110a represented by dashed boundary lines in FIGS. 1-3. The brewing machine components shown within the boundary lines are disposed on or in the brewing machine, while those outside the boundary lines are not disposed on or in the brewing machine. Brewing machine 101 depicted may be a single serve type brewing machine in some embodiments which uses disposable single-use sealed product container 101 such as sachets, packets, capsules pouches, cups, pods, or similar which hold the ground coffee or tea product in a dry state. The invention and concepts discloses herein however is not limited to such brewing machines alone.

Referring to FIG. 1, brewing machine 110 includes an internal water flow circuit 111 which provides a common source of water efficiently used for both brewing the hot base beverage (e.g., coffee or tea) and milk frothing. The fluidic components associated with the water flow circuit 111 generally include a float-controlled internal water reservoir or chamber 113, a water pump 114, a two-stage heating system comprising a pair of boilers 105a, 105b, flow bypass-mixing system 130 comprising a bypass-mixing valve 116, and a multi-branched network of flow conduits 117 configured as shown to fluidly interconnect or couple the foregoing components and other fluidic components together in the manner shown and described herein. Any suitable metallic or non-metallic (e.g., plastic) tubing may be used to form the flow conduits 117 depending on whether the particular flow conduit in question is handling cold or hot water and the applicable temperature and pressure conditions in various portions of the water flow circuit 111.

Water chamber 113 is located internally with respect to brewing machine 110 (i.e. housing 110a of the machine represented by the dashed boundary lines in FIG. 1). Chamber 113 has an inlet 113b which is fluidly coupled to a potable water source 118 used to fill the chamber with water W. Water source 118 in one embodiment may be an available pressurized filtered water source 118a such as those associated with an existing potable water system of the building or facility in which brewing machine 110 may be used. Shutoff valve 112 may be fluidly between the chamber 113 and filtered water source 118a. Valve 112 is operably coupled to and operated via a suitable commercially-available liquid level sensor 119 such a level switch mounted to the chamber 113. Other type level sensors may be used. Sensor 119 regardless of the type used is configured and operable to detect a liquid level of the water in the chamber. The shutoff valve 112 and level sensor 119 combination automatically controls filling the chamber 113 with water when the liquid level drops to a predetermined setpoint level programmed into level sensor or a programmable microprocessor-based controller onboard the brewing machine 110 which may control the overall brewing cycle. This ensures that the chamber contains an adequate volume of water for both brewing the hot beverage and frothing the milk.

In other possible implementations, the internal chamber 113 however may instead be fluidly coupled to a discrete external water module 118b in situations where there is no readily available external hookup to the building pressurized potable water system. The module may be a water tank or a water cooler in some embodiments.

The internal water chamber 113 may further include an upper overflow connection 119a directed to drain, a lower drain connection 119b for completely draining the chamber, and optionally an outlet filter 119c at the outlet 113a of the chamber. Any suitable type of water filter may be used.

The water flow circuit 111 may also include pressure relief valve 142 fluidly coupled at its inlet to the flow conduit 117 extending between boiler 105a and water pump 114 as shown in FIG. 1. Valve 142 is configured with a setpoint pressure which establishes the maximum system working pressure in the water flow circuit 111 to protect the system components from damage which might be caused by elevated pressures. In the event the actual system pressure exceeds the setpoint pressure Sp, valve 142 is configured to automatically open and discharge water in the circuit back to water chamber 113 to relieve the excess pressure in the system. Any suitable commercially-available relief valve may be used.

The flow circuit 111 may further include various check valves 120 as shown which are located throughout the branched network of flow conduits 117 to prevent backflow of water at various points in the system. Any suitable commercially-available check valves may be used.

Water pump 114 takes suction from water chamber 113 and is arranged between the chamber and boilers 105a, 105b (specifically upstream of the first boiler 105a in the water flow circuit 111. The pump is configured and operable to elevate the pressure of the water above atmospheric conditions (i.e. greater than 0 barg/1 bara). Pump 114 discharges the pressurized water to water heating tank 112a of boiler 105a as shown. Pump 114 is operable to pressurize the water for the brewing cycle and milk frothing operations. Any suitable type of commercially-available water pump may be used. In one embodiment, pump 114 may be low pressure DC operated type electric pump.

Boilers 105a, 105b each comprise respectively water heating tanks 112a, 112b equipped with electric heating element 115a, 115b of any suitable commercially-available type operable to heat the water inside the tanks. Electric resistance type heating coils or elements may be used in some embodiments. The heating elements may be mounted internally within the tanks or externally on the tanks and in conductive contact with the tanks. Temperature T1 of the water is established and maintained in tank 112a by regulating the electrical energy/power input to heating element 115a. Similarly, temperature T2 of the water is established and maintained in tank 112b by regulating the electrical energy/power input to heating element 115b. Temperature sensors 106a and 106b (e.g., thermistors, thermocouples, or other) may be provided to sense the water temperature in the tanks 112a, 112b and control the energy input into heating elements 115a and 115b to maintain the desired predetermined temperatures T1 and T2, respectively. Tanks 112a, 112b may preferably be formed a suitable metal designed for the pressure and temperature conditions experienced by the tanks.

The boilers 105a and 105b may be fluidly coupled together and arranged in series from a flow standpoint as shown and represented by the water flow arrows in the schematic flow diagram of FIG. 1 (i.e. boiler 105a is upstream of boiler 105b). Accordingly, in one operating scenario all of the water pumped by pump 114 may pass through boiler 105a and flow directly to and through boiler 105b. In another operating scenario however which may be used for brewing the primary beverage (e.g., coffee, tea, hot chocolate, etc.), a portion of the heated water output from boiler 105a may be extracted after leaving the boiler and bypass downstream boiler 105b via operation of a flow bypass-mixing system 130, as further described herein.

Each boiler 105a and 105b has a fluid inlet and outlet (indicated by the water flowpath directional flow arrows of water flow circuit 111 in FIG. 1). In the present embodiment of the hot beverage preparation system 100, boiler 105a in one non-limiting embodiment may be considered a “first stage” boiler configured and operable to heat the incoming water received from water chamber 113 via the motive pressurizing force of water pump 114 to a first temperature T1. T1 may be a non-superheated temperature meaning it is less than the boiling point of water at atmospheric press (100° C.), but higher than the incoming water to boiler 105a from the water chamber (which would be room temperature at its greatest-generally about 21-22° C.). In some non-limiting embodiments, T1 may be about and including 75-80° C.

Boiler 105b may be considered a “second stage” boiler configured and operable to heat water received directly from boiler 105a via a section of flow conduit 117 to a second temperature T2 which is higher than T1. In one embodiment, temperature T2 produced in the second stage boiler 105b may be a superheated temperature meaning that the temperature T2 of the liquid water in the water flow circuit 111 is above the boiling point of the water at atmospheric pressure (i.e. 100° C.). For example, at a system pressure of 1.5 barg in the present water flow circuit 111 downstream of pump 114, the boiling point of water increases to 127.4° C. Because temperature T2 of water leaving boiler 105b is greater than 100° C., it may be characterized as a superheated liquid which maintains the water in liquid state due to pressures in the water flow circuit 111 being greater than atmospheric pressure. In some embodiments, T2 discharged from boiler 105b may be about 130° C. at a pressure of about and including 2-3 barg. The superheated liquid water at temperature T2 produced by the second boiler 105b is suitable for injecting a jetted stream of this water while in liquid state without flashing to steam into the cup of the supplementary liquid L such as for example without limitation milk or milk substitute in some embodiments provided by the user for heating and frothing according to principles of the present disclosure, as further described herein.

It bears noting that the pressurized superheated liquid water at the foregoing final temperature and pressure conditions (e.g., 130° C. @ 2-3 barg) leaving the second stage boiler 105b however may not be suitable or ideal for brewing coffee or tea in brewing machine 110 to achieve optimum flavor of the hot beverage. For example, some consider ideal temperatures for brewing coffee and tea to be about 85° C. to 95° C. In addition, this elevated temperature T2 may exceed the maximum permissible design temperature limits of the coffee or tea product container 101 as well as going beyond the desired temperature for brewing the beverage. To reduce or temper the temperature T2 of the superheated water produced by the second stage boiler 105b of hot beverage preparation system 100 for brewing the beverage itself from the product container 101, a flow bypass-mixing system 130 is provided which is upstream of the brewing head 153 and its associated water injection nozzle 140.

Flow bypass-mixing system 130 in one embodiment may comprise a bypass flow line 131 formed by flow conduits 117, bypass-mixing valve 116 arranged in the flow line, and temperature sensor 132 operably coupled to the valve. Referring to FIG. 1, bypass flow line 131 is fluidly coupled at its inlet end to the flow conduit 117 fluidly connecting the discharge side (outlet) of the first stage boiler 105a to the inlet side of boiler 105b. The outlet end of the bypass flow line is fluidly coupled to the discharge side of the second stage boiler 105b by a fluid coupling 143, which may be for example a mixing tee or other configured fluid connection to the discharge flow conduit 117 leaving from the second stage boiler to the flow manifold 150.

Temperature sensor 132 is configured and operable to measure the blended or combined temperature Tc of the heated water discharged by the second stage boiler 105b and the portion of water from boiler 105a received from the bypass flow line 131 via bypass-mixing valve 116. Any suitable type of commercially-available temperature sensor may be used (e.g., thermistor, thermocouple, etc.). Sensor 132 may be coupled to the discharge side flow conduit 117 from the boiler 105b as shown in FIG. 1 downstream of the mixing tee or other fitting. Temperature sensor 132 is operably coupled to valve controller 116a of the bypass-mixing valve 116 via control wiring 133 and configured to measure real-time temperature Tc of the blended/combined water stream discharged by tank 112b of boiler 105b at temperature T2 and bypass water flow at temperature T1 from boiler 105a. The valve controller 116a is configured and operable to throttle the flow of water through the valve between its fully closed and fully open positions based on feedback from temperature sensor 132 until a desired brewing setpoint temperature Ts is reached. Any suitable type of commercially-available electronic valve controller may be used. The valve controller may be preprogrammed with a brewing setpoint temperature Ts which is therefore established and maintained by throttling flow of water at lower temperature T1 leaving first stage boiler 105a during the beverage brewing cycle. In some embodiments, valve controller 116a may be operably and communicably linked to the brewing machine main system controller 200, which may be configured to allow ready adjustment of the brewing setpoint temperature Ts by the manufacturer or end user via control panel 202, as further described herein.

In operation, a portion of the heated water at temperature T1 leaving boiler 105a is bypassed around boiler 105b and flows through the bypass-mixing valve 116. The bypassed portion of water is discharged into and mixed with the superheated water at higher temperature T2 leaving second stage boiler 105b via mixing tee 143 when the beverage brew cycle is initiated. Temperature Tc of blended/mixed water streams is therefore between temperatures T1 and T2 and selected to be the ideal temperature for brewing the hot beverage (e.g., coffee/tea). In one non-limiting example, the preprogrammed brewing setpoint temperature Ts may be for example about 95° C.; however, other temperatures below 100° C. may be used. Bypass-mixing valve 116 is throttled by system controller 200 and/or valve controller 116a until Ts=Tc.

To force a portion of the water exiting the first stage boiler 105a to take the flow path through the bypass flow line 133 and bypass-mixing valve 116 in lieu of the second stage boiler 105b, the discharge from the second stage boiler passes through a flow restrictor 125 fluidly coupled thereto as shown in FIG. 1. Restrictor 125 is sized to create sufficient flow resistance for this purpose, but to allow sufficient flow needed to pass and dispense a stream of the superheated water from boiler 105b through collimating nozzle 160 for heating and frothing the supplementary liquid L (e.g., milk, milk substitute, etc.).

Brewing machine 110 of hot beverage preparation system 100 further includes a beverage dispensing station 103 configured to receive and support the user's beverage container such as cup 104 into which the milk (or non-dairy milk substitute) and brewed are dispensed for consumption. Adjacent to and overhead of beverage dispensing station 103 in machine 110 is located fluid control station 151 comprising a branched flow manifold 150 formed from a linear section of a flow conduit 117. Manifold 150 is fluidly coupled to the discharge side flow conduit 117 from second stage boiler 105b (which in turn in fluidly coupled to the bypass flow line 131 previously described herein).

In one embodiment with continuing reference to FIG. 1, flow control station 151 may include in operable fluid coupling to manifold 150: (1) a frothing water dispensing head 152 formed by a control valve 155; (2) a brewing water injection head 153 formed by a control valve 156; and (3) a recirculation water head 154 formed by a control valve 157. Electric or air-operated solenoid valves may be used for control valves 155-157 in some embodiments. Valves 155-157 are each configured and operable to block or allow flow of water through each valve.

Return water head 154 formed by control valve 157 when opened operates to recirculate water in water flow circuit 111 via recirculation flow line 145 formed from the discharge of valve 157 in the back to water chamber 113 in a closed flow loop as shown in FIG. 1. Recirculation flow line 145 is fluidly coupled between the discharge of valve 157 back to the water chamber. In one use, the recirculation flow line 145 may be used to purge residual water remaining in the flow manifold 150 with air after one brewing cycle is completed before the next brewing cycle starts. Manifold 150 may therefore be fluidly coupled to an air pump 158 for this purpose. This removes any cooled water between brewing cycles which might decrease the desired brewing temperature. Control valve 157 may remain open to keep the recirculation flow line 145 in service while the manifold 150 is refilled with water for the next brewing cycle (air pump being shut off during this time).

Brewing water injection head 153 operates to inject hot water at a sub-superheated moderated blended temperature Tc/Ts (combined and brewing setpoint temperature previously described herein) between T2 and T1 during the brew cycle through product container 101 which contains the ground coffee or tea. Injection nozzle 140 fluidly coupled to the discharge of control valve 156 of beverage water injection head 153 is sized to help control the flowrate and pressure of hot water injected into the product container.

Frothing water dispensing head 152 operates to inject a pulsed jet or burst of hot superheated water at temperature T2 via collimating nozzle 160 fluidly coupled to control (e.g., solenoid) valve 155 into the user's beverage cup 104 for heating and frothing a volume of supplementary liquid (e.g., milk or non-dairy milk substitute) manually added into the cup in advance. Collimating nozzle 160 is configured to dispense a concentrated coherent or “collimated” free jetted stream of superheated water in a liquid state or condition. Nozzle 160 has a length and orifice configured to produce a collimated stream at a desired flowrate and velocity. The jetted superheated water emitted from the nozzle travels through ambient air into the cup of milk or milk substitute. Nozzle 160 is configured to dispense the collimated stream of superheated water in liquid state through air for a distance D1 and time without flashing to steam, as further described below.

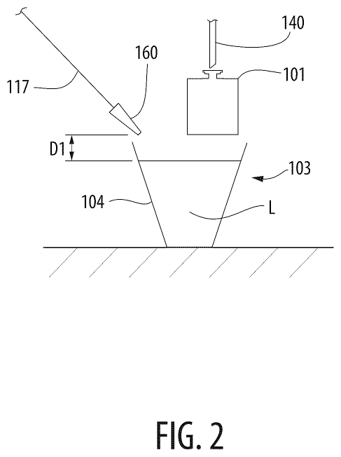

According to one unique aspect of the invention, the frothing water dispensing head 152 and collimating nozzle 160 are configured and arranged to inject a pulse or burst of the pressurized superheated water (e.g., stream) from boiler 105b in liquid state directly into the awaiting user's cup 104 of cool or cold liquid milk or milk substitute (supplementary liquid) before the water were to flash to steam when first exposed to atmospheric pressure. Referring to FIG. 2, the superheated liquid water is preferably injected in a non-contact manner with respect to the dairy or non-dairy liquid in the cup to advantageously avoid cross-contamination and cleaning of the jetting nozzle. In other words, the collimating nozzle 160 advantageously does not contact the surface of the in the cup. This is distinguishable from professional barista-style machines which inject steam from a nozzle or wand which must be manually immersed and dunked in the liquid by the user to froth the milk. The present non-contact milk or milk-substitute frothing operation therefore eliminates both contamination of the collimating nozzle and automatically froths the milk in the cup 104 after the cup is placed in the beverage dispensing station 103 of the brewing machine.

To accomplish the above fully automated non-contact liquid frothing, the terminal free end of the superheated water collimating nozzle 160 is spaced above the surface of the liquid milk or milk substitute in the user's cup 104 by a separation distance D1 as indicated in FIG. 2. Distance D1 is selected so that the collimated pulsed or jetted stream of superheated water remains in a liquid state as it travels through air upon leaving collimating nozzle 160 until the stream contacts the body or volume of liquid milk or milk substitute in cup 104 without flashing to steam when exposed to ambient atmosphere pressure. There is a lag time between when the superheated water stream is first exposed to atmosphere pressure after leaving the collimating nozzle 160 and when the superheated water would flash to steam at that pressure. Therefore, separation distance D1 is selected to take advantage of this delay in conversion of the superheated water from a liquid state to a vaporous state (i.e. steam) based on the lag time between these states in the presence of ambient atmospheric pressure. Distance D1 is therefore also proportional to the velocity of the stream of liquid superheated water discharged from collimating nozzle 160 which influences the lag time. The velocity is determined in part by the pressure in the system as well as nozzle configuration. The greater the velocity of the superheated water stream, the larger the distance D1 until the stream flashes to steam, and vice-versa. It is well within the ambit of those skilled in the art to select an appropriate separation distance D1 by taking into consideration the foregoing factors of lag time and stream velocity so that the stream of superheated water remains in liquid state until after contact with the milk or milk-substitute in the cup 104.

By injecting a stream or jet of superheated water into the supplementary milk or milk substitute of the user's beverage cup 104 to froth the liquid while the stream remains in a liquid state without flashing to steam, improved heating of the supplementary liquid is achieved as the thermal energy is not substantially dissipated and lost to atmosphere. The superheated stream will mix with the cool or cold supplementary in the cup (which may have come directly out of the refrigerator), thereby tempering the stream without flashing to steam altogether. In addition, by avoiding direct contact between the superheated water collimating nozzle 160 and supplementary liquid as explained above, there is no need for manual milk frothing and cleaning of the nozzle due to cross-contamination.

It bears noting that the separation distance D1 takes into consideration that the beverage dispensing station 103 of brewing machine 110 in some embodiments may be configured to accommodate beverage cups 104 of different sizes/volume and heights as well as varying levels of the supplementary liquid L (e.g., milk or milk substitute). Distance D1 between the free terminal end of the collimating nozzle 160 and the surface of the liquid may therefore vary based on cup size and how full the user fills the cup with the supplementary liquid. Accordingly, separation distance D1 is preferably select such that the nozzle 160 will not contact the liquid in the cup under any circumstances and varying cup sizes and liquid volumes.

The hot beverage preparation system 100 may further include a programmable system controller 200 located onboard the brewing machine 110 as shown in FIG. 1. Controller 200 is configured via programming with software instructions to control operation of the brewing machine and its components including without limitation the beverage brewing cycle, milk or milk substitute frothing, maintaining the cold water level in the water chamber 113, operating valves described herein including bypass-mixing valve 116 and control (e.g., solenoid) valves 155-157, sensing water temperatures measures by the temperature sensors discloses herein, and other functions. The controller 200 is operably coupled and linked to a user-accessible electronic control panel 202 onboard the machine 110. The panel provides an input device which allows the user to initiate the actions of the brewing machine for brewing the beverage and frothing the milk. Panel 202 may include the usual appurtenances for such purposes such as hard and/or soft buttons, status lights, display screen, etc.

The programmable controller 200 may include one or more microprocessors or processors, a system on a chip (integrated circuit), or combinations thereof which execute the program or software instructions (e.g., control logic) that control operations of the brewing machine 110 and cause the hot beverage preparation system 100 to perform the operations and methods disclosed herein associated with preparation of the final hot beverage. Controller 200 includes non-transitory tangible computer or machine accessible and readable medium such as memory 201 on which the software and various system setpoints or baseline parameters (e.g., temperatures, pressures, etc.) described herein are stored and accessed by the microprocessor(s). Memory 201 of the machine readable medium may include any suitable volatile memory and non-volatile memory or devices operably and communicably coupled to the microprocessor(s). Any suitable combination and types of volatile or non-volatile memory may be used including as examples, without limitation, random access memory (RAM) and various types thereof, read-only memory (ROM) and various types thereof, hard disks, solid-state drives, flash memory, or other memory and devices which may be written to and/or read by the processor operably connected to the medium. Both the volatile memory and the non-volatile memory may be used for storing the program instructions or software.

Controller 200 includes all other electronic devices/components, peripherals, appurtenances, power management system, communication interfaces (hard wired and/or wireless connections), etc. not mentioned herein for the sake of brevity which are customarily supplied with a controller to provide a fully functional control system.

A method or process for preparing a beverage using the brewing machine 110 of hot beverage preparation system 100 previously described herein will now be summarized. Reference is made to FIGS. 1 and 2 and the foregoing discussion. The actions described below and operation of the components indicated are initiated by the system controller 200 unless otherwise noted.

To initially set up the system and begin the process, the water chamber is filled with cold water from water source 118. Water pump 114 is activated by controller 200 to prime the flow conduits 117 and boilers 105a, 105b in the water flow circuit 111 with water and ready the system for operation. Control (solenoid) valves 155-157 coupled to flow manifold 150 previously described herein may be initially in a closed position. Bypass-mixing valve 116 is initially in a closed position so that that water flows in the circuit directly from first stage boiler 105a to the superheating second stage boiler 105b via the interconnecting flow conduit 117. Once the flow circuit 111 is primed, heating coils 115a, 115b in the boilers are activated by controller 200 to heat the water in each tank 112a, 112b to the respective setpoint temperatures T1 (below superheated liquid condition) and T2 (superheated liquid condition) previously described herein. The system is now ready for milk (or milk substitute) frothing and brewing the beverage.

The milk (or milk substitute) frothing operation may be performed first in one embodiment. The user adds a volume of the cool/cold supplementary liquid L such as milk or substitute into beverage cup 104 and places/positions the cup in the beverage dispensing station 103 of brewing machine 110. The volume may be a predetermined recommended amount to ensure optimum heating and frothing of the liquid in the cup is achieved, or may be more or less than that depending on the preferences of the user. The brewing machine 100 is operable to heat and froth the liquid L in a non-contact manner regardless of the volume of milk added, as further described herein.

The frothing collimating nozzle 160 and brewing water injection nozzle 140 are located adjacent to each other in the dispensing station 103 and spaced above the cup when positioned in the dispensing station. In a first control scenario, the user may initiate the entire milk frothing and subsequent brewing cycle by actuating a single hard button and/or soft (software) button on control panel 202. In a second control scenario, the control panel may be configured with a separate hard or soft button to initiate the frothing operation and a separate hard or soft button to initiate the beverage brewing cycle. This second setup would allow the user to froth milk or other liquids including simply water for other reasons without activating the brewing cycle.

In either the first or second control scenarios, the programmable controller 200 opens the frothing solenoid control valve 155 (initially in a closed position) to release superheated water in liquid state from the superheating second stage boiler 105b. The water is at a superheated temperature and pressure greater than ambient atmospheric air pressure (e.g., 2-3 barg or other) which prevents the superheated water from flashing to steam. A pulsed jet or stream of the collimated superheated water in liquid state is shot or injected into the supplementary liquid such as milk (or milk-substitute) previously emplaced by the user in the beverage cup 104. The stream lasts for a period of time sufficient to heat and properly froth the supplementary liquid until terminated by closing control valve 155 via controller 200.

The superheated water stream heats the supplementary liquid after contact with the liquid in the cup without flashing to steam when first exposed to the lower ambient atmospheric air pressure as the water leaves the collimating nozzle 160 (recalling that water boils at 100° C. at atmospheric pressure). Selection of the proper separation distance D1 between the surface of liquid in cup 104 and free end of frothing collimating nozzle 160 as previously described herein ensures that the collimated superheated water remains in the liquid state as it contacts the supplementary liquid in cup 104 without changing to the vaporous state (steam) when first exposed to ambient air and atmospheric pressure. The superheated water thus is tempered and cools rapidly without flashing to steam after being injected into and mixing with the supplementary liquid. The heated and frothed the milk or milk substitute prepared in this manner is read for use in making the final beverages such as a cappuccino, latte, macchiato, and the like.

Advantageously, it bears noting that the superheated liquid water injection at temperature T2 (i.e. superheated conditions) heats the milk or milk substitute more effectively and with less volume of water than using hot water injection at temperatures below the boiling point of water at ambient atmospheric pressure (100° C.). This results in less dilution of the final brewed coffee or tea beverage to retain optimum strength and richness of flavor of the vended beverage. In addition, the superheated liquid water further produces hotter frothed milk or milk substitute resulting in a final brewed drink or beverage temperature which may be about 10-15° C. hotter by contrast than using hot water at lower temperature conditions below 100° C. (i.e. not superheated).

Continuing with the beverage preparation process/method now, the jetted stream of superheated water in liquid state is stopped after a timer of predetermined duration programmed into system controller 200 times out. Controller 200 returns the frothing control valve 155 to the closed position. The duration of time that superheated water is injected into the supplementary liquid (milk or milk substitute) is selected to ensure that a sufficient volume of superheated water is injected into cup 104 to adequately heat the volume or milk (or milk substitute) initially added to the cup by the user, but without resulting in undue dilution of this supplementary liquid.

After the milk frothing step is completed, the controller 200 activates the hot beverage brewing cycle which is automatically initiated (in the first control scenario described above), or upon the user manually actuating a second brew cycle button (hard or soft) on control panel 202 (in the second control scenario described above). In either case, controller 200 opens bypass-mixing valve 116 to mix a portion of the lower non-superheated temperature water from first stage boiler 105a at temperature T1 with higher superheated temperature water from second stage boiler 105b via the mixing tee 143. Valve 116 is throttled open by an amount based on the temperature Tc of the blended/mixed water stream measured in real-time by temperature sensor 132 downstream of the mixing tee 143 at the discharge side of boiler 105b (see, e.g., FIG. 1). The controller 200 opens bypass-mixing valve 116 by a percentage between 0 percent (fully closed) and 100 percent (fully open) until brewing setpoint temperature Ts is reached. Controller 200 actively compares the actual measured water temperature Tc with the preprogrammed setpoint temperature Ts for this purpose.

As previously described herein, temperature Ts represents the predetermined desired brewing setpoint temperature at less than superheated conditions for the hot brewing water to brew the beverage. Temperature Ts is between temperatures T1 and T2. Setpoint temperature Ts may be about 95 degrees in one non-limiting example recognizing that higher brewing temperatures (but below 100° C. to avoid flashing inside the brewing machine 110) or lower brewing temperatures may be used.

In some operating modes, recirculation water control valve 157 may optionally be opened by controller 200 to establish the closed flow loop previously described herein through the water flow circuit 111 until the water temperature of the mixed stream or flow is reduced to the brewing setpoint temperature Ts by progressively opening and modulating water bypass-mixing valve 116. In the closed flow loop, the mixed water flow is extracted from manifold 150 via control valve 157 and flows back through recirculation flow line 145 to water chamber 113 where it is mixed with cold water. The recirculated water is pumped out of chamber 113 by pump 114 and back through the first and second stage boilers 105a, 105b to the manifold 150 to complete the closed flow loop circuit.

When setpoint temperature Ts of the mixed water flow is reached based on the controller comparing the setpoint temperature to the real-time or actual water temperature Tc measured by temperature sensor 132 and communicated to the controller, the controller 200 closes recirculation control valve 157 to stop the recirculation flow in the closed flow loop. Preferably, the controller may concurrently open brewing water injection control (solenoid) valve 156. Control valve 156 injects heated water at the sub-superheated temperature Tc/Ts via injection nozzle 140 into product container 101 which dispenses the brewed beverage (e.g., coffee or tea) into cup 104 containing the hot frothed milk or milk substitute prepared in the prior step of the method or process. It bears noting that the user need not move the cup after initial placement in the beverage dispensing station 103 of brewing machine 110 for either the frothing or beverage dispensing steps of the process. Once brewed, the user may remove the final and finished hot beverage from the brewing machine for consumption.

It bears noting that in embodiments provided with tandem water boilers 105a, 105b and the bypass system previously described herein (including bypass flow line 131 and bypass-mixing valve 116), this arrangement may be used to allow the user to select and automatically control the brewing water temperature Tc by setting the setpoint temperature Ts via programmable system controller 200. This may be accomplished in systems with superheated water milk frothing previously described herein, systems which are not configured and set up to produce superheated water for milk frothing, or if the user elects to simply brew the beverage alone without frothing (e.g., black coffee or tea) with/without superheated water milk frothing. The user selects and programs the desired brewing setpoint temperature Ts of the water via control panel 202 (preferably less than 100° C. to prevent steam flashing within water flow circuit 111), the controller adjusts the water temperature by throttling the bypass-mixing valve 116 in the manner previously described herein. Accordingly, the bypass system is usable independently of whether or not the brewing system is configured to generate superheated water for milk frothing.

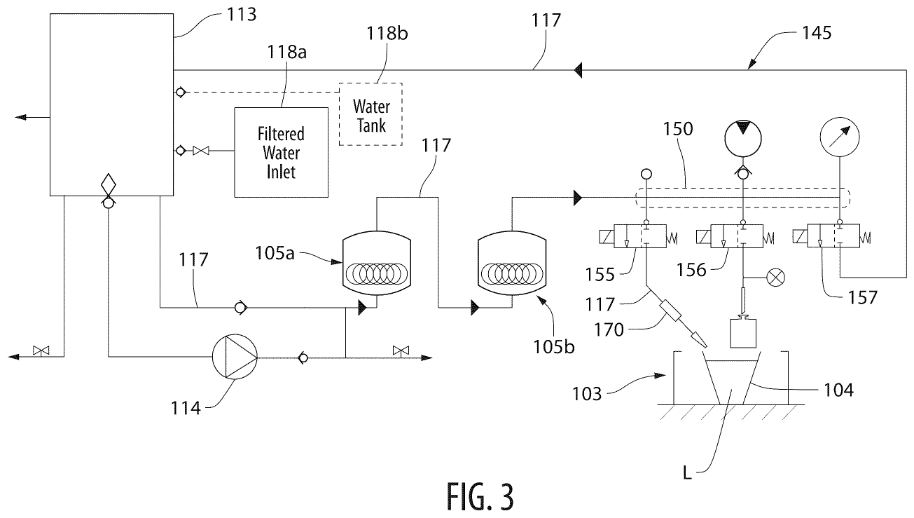

FIG. 3 depicts an alternative embodiment of the hot beverage preparation machine 110 similar to that of FIG. 1, but without the flow bypass-mixing system 130 and adding a flash heater 170 instead for heating the water to generate superheated water in liquid state for frothing the supplementary liquid L. Flash heater 170 is located between control valve 155 and collimating nozzle 160 within a flow conduit 117. Flash heater 170 may be any suitable commercially-available electric heater in some embodiments such as a flexible thin film heater which may be applied or wrapped around the flow conduit 117 proximate to the collimating nozzle. Other types of commercially-available heaters suitable for this application may be used such as a heated water block through which the water flows. It is well within the ambit of those skilled in the art to select an appropriate type/style and heating capacity of such foregoing heaters capable of heating the water to superheated conditions under pressures above atmospheric to maintain the liquid state.

In the illustrated embodiment of FIG. 3, the flash heater 170 receives water heated by the upstream tandem boilers 105a, 105b to temperature T1 below superheated conditions (e.g., less than 100° C.) as previously described herein. With the use of the flash heater, the second stage heater 105b is not configured or operable to generate the superheated frothing water. One operating scenario which may be used is to heat the unheated water from pump 114 to the desired brewing setpoint temperature Ts in two-stages using the tandem boilers. For example, first stage boiler 105a may heat to the water in one operating scenario to about 75-80° C. and second stage boiler 105b may then elevate the temperature of the water to a higher temperature such as the final preprogrammed desired brewing setpoint temperature Ts which in one non-limiting example may be about 95° C. The superheat flash heater 170 then elevates the heated water at setpoint temperature Tb dispensed from second stage boiler 105b to superheated conditions (e.g., T2 about 130° C. or other temperature above 100° C.). The supplementary liquid L (e.g., milk or milk substitute) in beverage cup 104 is heated and frothed using collimating nozzle 170 which injects the stream of superheated liquid water into the cup in the same manner previously described herein.

In some embodiments of the flash heating system, the flow bypass-mixing system 130 may be retained and arranged the same as in FIG. 1 for use in conjunction with flash heater 170 to allow the manufacturer or user to adjust and program the desired beverage brewing setpoint temperature Ts into controller 200 for the brewing cycle, as previously described herein.

Although the use of tandem boilers 105a, 105b is described above in conjunction with the superheating flash heater 170, use of a flash heater is not necessarily limited to use with tandem boilers. In some embodiments, a single one of boilers 105a or 105b may be used instead to alone heat the water to the desired brewing setpoint temperature Ts for brewing the beverage. The flash heater 170 is used in the same manner described above to superheat this water to superheated conditions (temperature T2) while remaining in liquid state for heating and frothing the supplementary liquid L (e.g., milk or milk substitute).

As will be readily apparent from the discuss above, numerous equipment and operating scenarios are possible using the various embodiments of the beverage preparation system disclosed herein to heat and froth the supplementary liquid and brew the beverage.

While the foregoing description and drawings represent exemplary (“example”) embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A method for preparing brewed beverage comprising:
providing a beverage brewing machine exposed to atmospheric pressure;
heating water in the machine to produce superheated water in a liquid state at a pressure greater than atmospheric pressure;
injecting a stream of the superheated water from a collimating nozzle into a volume of a dairy or non-dairy supplementary liquid in a beverage cup; and
heating and frothing the supplementary liquid with the superheated water;
wherein the collimating nozzle does not contact the supplementary liquid in the beverage cup.

2. The method according to claim 1, wherein the collimating nozzle is spaced apart from a surface of the supplementary liquid in the beverage cup by a separation distance so that the stream of superheated water travels through air before contacting the supplementary liquid.

3. The method according to claim 2, wherein the separation distance is selected so that the stream of superheated water does not flash to steam when exposed to the atmospheric pressure and remains in the liquid state when it mixes with the supplementary liquid in the beverage cup.

4. (canceled)

5. (canceled)

6. The method according to claim 1, wherein the water heating step comprises:
heating the water in a first stage boiler to a first temperature, the first temperature being below superheated conditions;
heating the water in a second stage boiler to a higher second temperature to produce the superheated water in the liquid state.

7. The method according to claim 6, further comprising after the heating and frothing step, additional steps of brewing a beverage in the machine and dispensing the beverage into the heated and frothed supplementary liquid to the cup, wherein the brewing step includes mixing a portion of water at the first temperature from the first stage boiler with the superheated water at the second temperature from the second stage boiler to produce brewing water at a third temperature between the first and second temperatures, and further comprising injecting the brewing water at the third temperature through a product container holding a beverage substance selected from the group consisting of coffee, tea, and cocoa into the cup.

8. (canceled)

9. (canceled)

10. The method according to claim 1, wherein the water heating step comprises passing the water through a flash heater arranged upstream of the collimating nozzle to produce the superheated water in the liquid state.

11. The method according to claim 10, further comprising:
before passing the water through the flash heater, first heating the water in a first boiler to a first temperature, the first temperature being below superheated conditions; and
before passing the water through the flash heater, heating the water in a second boiler to a second temperature the same as or higher than the first temperature, the second temperature being below superheated conditions.

12. (canceled)

13. (canceled)

14. The method according to claim 6, wherein the first temperature which is less than 100° C. and the second temperature is greater than 100° C.

15. The method according to claim 1, wherein the superheated water in the liquid state has a temperature which is greater than 100° C.

16. A beverage brewing machine comprising:
a water chamber configured to hold water;
a first stage boiler fluidly coupled to an outlet of the water chamber, the first stage boiler configured to heat the water to a first temperature;
a second stage boiler fluidly coupled to an outlet of the first stage boiler, the second stage boiler configured to heat the water received from the first stage boiler to a second temperature higher than the first temperature; and
a flow bypass-mixing system configured to extract and bypass a portion of the water discharged by the first stage boiler around the second stage boiler and combine the bypassed portion with a discharge of the water from second stage boiler creating a combined flow of water.

17. The beverage brewing machine according to claim 16, wherein the combined flow of water has a third temperature between the first and second temperatures, and wherein the third temperature is less than 100° C.

18. (canceled)

19. The beverage brewing machine according to claim 17, wherein the flow bypass-mixing system comprises:
a bypass flow line fluidly coupled at one end to a flow conduit between the outlet of the first stage boiler and an inlet of the second stage boiler, and at another end to a discharge flow conduit fluidly coupled to an outlet of the second stage boiler; and
a bypass-mixing valve arranged in the bypass flow line, the bypass-mixing valve being operable to throttle and adjust a flow of the bypassed portion of water flowable through the bypass flow line.

20. (canceled)

21. The beverage brewing machine according to claim 19, further comprising a temperature sensor arranged to measure a real-time temperature of the combined flow of water, the temperature sensor being operably coupled to the bypass-mixing valve, and wherein the bypass-mixing valve is configured to adjust the flow of the bypassed portion of water based on the sensed real-time temperature of the combined flow of water.

22. (canceled)

23. (canceled)

24. The beverage brewing machine according to claim 16, wherein the second stage boiler is configured to heat the water to produce superheated water in a liquid state at the second temperature which is greater than 100° C., and wherein the first stage boiler is configured to produce water at the first temperature which is less than 100° C.

25. (canceled)

26. (canceled)

27. The beverage brewing machine according to claim 17, wherein the second temperature is greater than 100° C.

28. The beverage brewing machine according to claim 16, further comprising a flash heater fluidly coupled to the second stage boiler, the flash heater operable to heat water received from the second stage boiler to produce superheated water remaining in a liquid state.

29. The beverage brewing machine according to claim 28, further comprising a collimating nozzle fluidly coupled to the flash heater, the collimating nozzle configured to emit a stream of the superheated water in the liquid state.

30. The beverage brewing machine according to claim 24, further comprising a collimating nozzle fluidly coupled to the second stage boiler, the collimating nozzle configured to emit a stream of the superheated water in the liquid state, wherein the collimating nozzle is configured to emit the stream of the superheated water through air into an awaiting supplementary liquid in a beverage cup positionable adjacent to the brewing machine such that the nozzle does not contact the supplementary liquid.

31. The beverage brewing machine according to claim 21, further comprising a programmable controller operably coupled to and controlling operation of the bypass-mixing valve, temperature sensor, and the first and second stage boilers.

32. The beverage brewing machine according to claim 31, wherein the controller is configured and operable to:
detect the sensed real-time temperature of the combined flow of water via the temperature sensor;
compared the sensed real-time temperature to a preprogrammed setpoint temperature; and
cause the bypass-mixing valve to adjust the flow of the bypassed portion of water based on the comparison between the sensed real-time temperature and the setpoint temperature.
